(19) United States
(12) Patent Application Publication
(10) Pub. No.: US 2019/0050758 A1
(43) Pub. Date: Feb. 14, 2019

(54) SYSTEM AND METHOD FOR GROUPING PASSENGERS TOGETHER IN AN AUTOMATED COLLECTIVE FORM OF TRANSPORT

(71) Applicant: MODUTRAM MEXICO, S.A. DE. C.V., Zapopan, Jalisco (MX)

(72) Inventors: Alexander Leopold KYLLMANN, Zapopan (MX); Fernando MIJARES VALLES, Zapopan (MX)

(21) Appl. No.: 15/115,600

(22) PCT Filed: Jan. 30, 2014
(86) PCT No.: PCT/MX14/00035

§ 371 Date: Jun. 12, 2017

(51) Int. Cl. G06Q 10/02; G07C 9/00; G01C 21/34; G06Q 50/30

(52) U.S. Cl. CPC G06Q 10/02; G06Q 50/30; G01C 21/3438; G07C 9/00857

(57) ABSTRACT

A system and method whereby passengers with common destinations and profile preferences are grouped so that the waiting and journey times for most passengers are reduced, the maximum capacity of the transportation can be used in peak hours, and passengers are given the possibility of choosing which other passengers they prefer to travel with in the same vehicle.

### PURPOSE OF THE INVENTION

A system and method is presented whereby passengers with common destinations and preference profiles are grouped together so that: a) the waiting and journey times are for most passengers are reduced, b) the maximum capacity of the urban collective transportation can be used in peak hours, and c) passengers are given the possibility of choosing which other passengers they prefer to travel with in the same vehicle.

The system allows advance reservations to be made for future journeys although the vehicle in which that journey will be made is not assigned at the time of the reservation, but instead just when the passenger arrives at the station and checks in. Through the check-in of the passengers upon arrival at the station, information about the immediate actual demand for journeys (origin, destination, time) does not remain in the passengers' heads; it is transmitted to a computer system so that in a very short time the routes and timetables of the vehicles are automatically adjusted. The number of vehicles departing from any station to any other station is dynamically adjusted to the actual short-term travel demand between those stations, at any time (i.e., during peak hours and off-peak hours).

Journeys can be offered from any station to any other station that has a track/roadway connection, with a minimum number of intermediate stops, and the number of destinations served from that station is not limited by physical space constraints at the station.

Different physical spaces are not delimited at the stations to serve different destinations (or groups of destinations). Passengers are streamed before they reach the boarding platform, in a natural and intuitive way (using boarding groups with consecutive numbers), so that the passengers reach the boarding platform in the same order as that in which the vehicles with the different destinations to which the passengers are traveling pass through.

Passengers are given access to the boarding platform (boarding point) for a limited time period, calculated so that the passenger reaches the boarding platform and boards his/her vehicle without remaining on the boarding platform any longer than is necessary. The consecutive number displayed by a vehicle inside a station matches the boarding group to which it was assigned at that station only, and it may be different than the consecutive number assigned to it at the next station. The assignment of passengers to the vehicles (through the boarding groups) and the scheduling of the vehicles' destinations is dynamic and is done on the fly to maximize the occupancy of each vehicle, with the possibility of being changed if needed and without the users realizing it, just before the vehicles that will serve the demand come through the station to pick up the passengers. The assignment of passengers to vehicles at a station (N) may also take into account available seats on vehicles that are traveling between two other stations (different than N), to optimize the total use of resources.

The passengers do not wait inside parked vehicles, since this blocks (ties up) the systems resources, or on boarding platforms where a buildup of passengers with different destinations can cause much confusion, but instead in the stations' lobbies. The predefined maximum waiting time does not need to be the same for all users. The predefined maximum waiting time may be directly related to the time difference between the check-in time according to the reservation and the actual check-in time.

The system allows passengers with compatible profile preferences to be grouped together for the collective use of vehicles. The grouping of passengers with compatible profiles is done on the fly without the need for the passengers sharing a vehicle to have arranged it among themselves beforehand. The grouping of passengers with compatible profiles does not need to happen entirely at the same station. The grouping of passengers may take into account temporary profile preferences, made by the user just before the journey (for example, traveling in silence or with conversation), in addition to the predefined fixed profile.

### BACKGROUND

Collective transportation, whether public (bus, subway, light rail, suburban rail, etc.) or private (chartered school bus or business bus, shared private automobile, etc.) offers the advantage of being more efficient in terms of the use of space, energy, and material resources compared with individual motorized transportation (non-shared private automobile). However, individual motorized transportation usually offers a higher level of convenience and comfort than collective transportation. Therefore, in many cities there has been accelerated growth in the number of private cars over several decades. The consequence of the rising use of individual motorized transportation is increasingly worse traffic congestion, accompanied by greater pollution and loss of productivity and quality of life of the urban population.

To reduce the congestion and its associated effects it would be desirable to increase the proportional use of collective transportation. The dilemma lies in the fact that the characteristics that make collective transportation more efficient and sustainable than individual transportation are precisely those that make it less appealing.

In the case of public collective transportation, the user shares the vehicle with other unknown users, which may be uncomfortable or may represent a security risk—actual or perceived—for certain users: children or women traveling alone, the elderly, or executives (to name a few examples), particularly during peak hours. In addition, the vehicle makes intermediate stops that are not related to reason for user journey, but which are necessary to serve the other users, which, combined with the need for transferring between vehicles, automatically means that the travel time for each user is higher than that which is really needed to get from the origin to the destination. Thirdly, given that there are intervals of time between one vehicle and the next, the user is subject to predetermined service timetables.

In the case of private collective transportation, although the users with whom the vehicle is shared are no longer unknown and some (or possibly all) of the intermediate stops are eliminated, it is normally a single vehicle traveling a certain route picking up passengers to arrive at a common destination (or distributing passengers who boarded at a common origin). The user has to abide by the timetable of that vehicle alone otherwise he/she loses the opportunity to make use of the service on that occasion.

In short, from the user's point of view, collective transportation has one or more of the following limitations: (1) travel in a shared vehicle without having an acquaintance aboard may be awkward or unsafe; (2) too many “unnecessary” intermediate stops that lengthen the journey time; (3) line or vehicle transfers that do not create added value for the user and that also lengthen the journey time; (4) the need to abide by fixed or external timetables, which represent a loss of flexibility. There are as yet no solutions that make collective transportation as appealing as individual transportation for a large part of the population.

### Existing Problems and State of the Art

Over the past 5 years, the world has witnessed the application of new and improved transportation technologies to meet mobility needs while at the same time reducing the environmental impact. These systems include the so-called PRT (“Personal Rapid Transit”) and GRT (“Group Rapid Transit”) systems, both based on fleets of automated vehicles (with no human driver).

PRT systems typically use small vehicles capable of carrying up to four passengers and they offer an on-demand individual service, like automated taxis. A significant characteristic of PRT systems is that they use their own completely interconnected track or road network, and that the stations are situated in side lanes (“off-line”), which enables the vehicles to make non-stop origin-to-destination journeys. As a result, the travel experience for the user is very similar to that of a journey by private automobile. In addition, given that each PRT vehicle serves several customers throughout the day, the use of resources is more efficient than it is in the case of private automobiles. However, with an individualized service, PRT systems fail to offer mass transportation capacity during peak hours; therefore, it is necessary to consider the shared use of vehicles for a PRT operation to be technically and economically viable, as well as ecologically sustainable, otherwise it just replicates the model of the private car on a new track or road infrastructure.

GRT systems, like PRT systems, use their own, completely interconnected track or road network, with stations situated in side lanes (“off-line”). However, unlike PRT systems, GRT systems offer a collective service and can use vehicles with capacity for up to about 20 passengers. As the stations are located on side lane (“off-line”), GRT vehicles do not need to stop at each station along the route; it is possible to offer “express” services with stops at certain stations only. This reduces the number of intermediate stops that are unnecessary from the standpoint of a particular user.

In fact, GRT systems can be seen as horizontal elevators.

With the introduction of fully automated automobiles, it is likely that automated taxi and/or ridesharing services will appear in the near future that would function like PRT and GRT systems but without the need for an additional exclusive track or road network.

In any case, to optimize the use of a fleet of automated vehicles (using their maximum capacity during peak hours and minimizing the use of energy in off-peak hours), it is necessary to resolve the following issues:

a) how to group passengers together to be able to meet the expected demand during peak hours, minimizing the number of vehicles and the additional infrastructure required;

b) how to group passengers together to minimize their discomfort or insecurity, both real and perceived;

c) how to group passengers together without causing confusion at stations and without disproportionately increasing the space occupied by the stations;

d) how to offer a collective transportation service that does not subject users to rigid timetables or excessively lengthy journey times in order to provide service to other users with whom the vehicle is shared; and

e) how to offer a service that minimizes the total average journey time (waiting time+journey time) for all passengers.

### BRIEF DESCRIPTION OF THE INVENTION

This invention relates to a system and method of grouping passengers in automated collective transportation, comprising a plurality of vehicles and a plurality of stations where users are able to get on and off vehicles, and the station comprises a zone without controlled access and a zone with controlled access; a computer system (3) with a database (4) of users with information about certain attributes of each user and the preferences of each user compared with the attributes of other users; an identification device (1) that unmistakably identifies the user bearing this device to the system; at least one recognition device (2) fitted at each station capable of reading or extracting relevant information contained in the identification device and sending this information to the computer system; at least one display device or medium (6) placed in the zone without controlled access of the stations, capable of displaying information generated by the computer system and indicating which user or group of users can go through to the zone of the boarding platform and at what time; at least one access control mechanism or device (7) fitted at each station capable of allowing or denying passage to the user, according to instructions from the computer system, from zone without controlled access of the station to the controlled access zone where access is restricted to users that are able to board the vehicles on the boarding point or platform; at least one indicator device (5) capable of receiving information generated by the computer system and of transmitting this information to the user, containing a customized instruction which the user is to follow in order to board the specific vehicle that will take the user to his/her destination; at least a second display device or medium (8) placed in each vehicle, capable of displaying information generated by the computer system and indicating the destination or destinations of that vehicle and the users or groups of users who are to board it; and means of communication (9) between the computer system (3, 4) and each of the devices (1, 2, 5, 6, 7, 8).

### BRIEF DESCRIPTION OF FIGURES

FIG. 1 shows a schematic view of the System for grouping passengers in automated collective transportation.

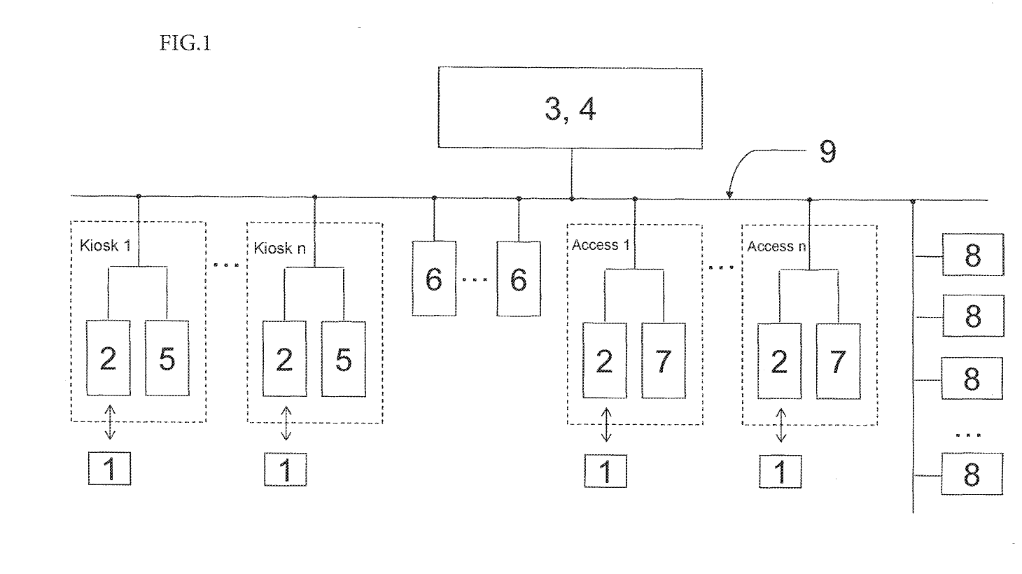

### DETAILED DESCRIPTION OF THE INVENTION

The minimum elements that comprise the system for grouping passengers in automated collective transportation that minimizes the passengers' waiting and travel times, allows them to travel with other passengers with common profiles, and which optimizes the use of resources in the transportation system, comprise:
A plurality of vehicles;
A plurality of stations in which users can get on and off vehicles, each station comprising an zone without controlled access and a controlled access zone;
A plurality of identification devices (1), on which are recorded data identifying the user bearing one of these devices;
At least one recognition device (2) for the user identification data recorded on the identification device (1);
A computer system (3) with trip scheduling software;
A database (4) of users with information about certain attributes of each user and the preferences of each user compared with the attributes of other users;
At least one indicator device (5) capable of receiving information generated by the computer system (3) and of transmitting this information to the user, containing a boarding group identifier or another customized instruction which the user is to follow in order to board the specific vehicle that will take the user to his/her destination;
At least one display device or medium (6) placed in the zone without controlled access of the stations, capable of displaying information generated by the computer system (3) and indicating which user or group of users can pass to the boarding platform zone and at what time;
At least one access control mechanism or device (7) fitted at each station capable of allowing or denying passage to the user, according to instructions from the computer system (3), from the zone without controlled access of the station to the controlled access zone where access is restricted to users who are able to board the vehicles on the boarding point or platform;
At least a second display device or medium (8) placed in each vehicle, capable of displaying information generated by the computer system (3) and indicating the destination or destinations of that vehicle and the users or groups of users who are to board it;
means for transmitting information (9) between the computer system (3), the database (4) and each of the devices (1, 2, 5, 6, 7, 8).

Each user has an identification device (1) with which they can be unmistakably identified upon arrival at a station (and optionally when boarding a vehicle). This identification device may be a one of a card with a chip on which certain details of the user are programed, a mobile computer or mobile telecommunication device with a specific computer application (“smartphone,” tablet computer, etc.), a card with a magnetic strip, an RFID-style card, etc.

In the lobby of each station (uncontrolled access zone) are installed one or more kiosks, either electronic or served by employees, at which users are able to purchase tickets, make future travel reservations, and check in for a trip in this time. Each kiosk has a recognition device (2) and an indicator device (5). The recognition device (2) is capable of reading and decoding the identification information recorded on the users' identification devices (1), preferably without direct contact between the recognition device and identification device, and of sending the information it reads to the computer system (3). This recognition device may be one or a combination of a barcode reader, a QR code reader, an electromagnetic strip reader, an RFID recognition antenna, a biometric sensor, etc. The indicator device (5) may be a printer that prints a disposable slip on which the user's boarding group identifier (turn number) is indicated.

If the user has a mobile telephone or a mobile computer device with Internet access, this can perform the functions of the indicator device (5). Additionally, if the telephone or computer has a geolocation function, this can perform the functions of the recognition device (2).

The entrance to the station's platforms (entrance to the controlled access zone) is fitted with at least one access control mechanism (7) to the boarding platform and at least one display device or medium (6). The display device or medium is preferably a screen, and the access control mechanisms (7) to the boarding platform are typically turnstiles or gates. Each access control mechanism has a recognition device (2). The device (2) is capable of reading and decoding the identification information recorded on the users' identification devices (1), preferably without direct contact between the reading device and identification device. At least one display device or medium (6) is located and is of sufficient size to be able to be read by the users from any point in the station's lobby.

Each vehicle is also fitted with at least a second display device (8), which is mounted so that the information displayed can be seen from outside the vehicle, and optionally a recognition device (2) on each door. This second display device (8) may be one or a combination of a visual medium and a sound medium; the visual medium being a screen and the sound medium being an audio system.

The computer system (3) and the database (4) are normally located in a centralized computer room. The database (3) contains a record for each user with their official identification details, optionally their username (unique name invented by the user), their own “profile” (default groups of users of which they are a member) and their preferences for vehicle sharing. These preferences are defined as a list of compatible profiles, i.e., profiles of other users with whom they are willing to share the vehicle. These lists of compatible profiles may contain names of specific users or predefined groups of users. For example, the compatible profiles of the user X may be “Women” or “Students of the School X” or “Employees of the company Z” or “All my Facebook friends.” For security reasons, the system might require the user to be a member of the predefined groups they decide to include as compatible profiles.

The method for grouping passengers in automated collective transportation comprises the following stages, each with their steps:

I) Initialization

1. The user X registers with the system (for example, through a website, an electronic kiosk, a computer application installed on a mobile computing and telecommunication device or by telephone), thereby creating a record in the database (4) for that user.

2. The user X provides their official identification data, chooses or creates a username, and sets their password.

3. The user X defines their own profile and their preferences for vehicle sharing. The fewer the restrictions that are established in the preferences or the larger the lists of “compatible profiles” there are, the easier it will be for the system to be able to find other users with whom to share a vehicle.

4. If the user X does not have a mobile computing and telecommunication device with the specific computer application, the user purchases or receives an identification card, which is linked to the record of that user in the database (4).

II) Reservation and check-in

1. The user X reserves a future journey from an origin station N to a destination station D, departing at the desired time. They can make this reservation through a website, an electronic kiosk at a station, a computer application installed on their own mobile computing and telecommunication device, or by telephone.

This step is optional.

2. The computer system (3) receives the reservation request from the user X and sets aside a certain capacity of the transportation system's resources to serve that request, without necessarily assigning a specific vehicle at the time of the reservation.

3. The user X arrives at the station N and presents his/her identification means or device (1) to the reader (2).

4. If the user X does not already have a reservation made previously (in step 1), they make it at that time by selecting their destination D.

5. The reader (2) sends a notification to the computer system (3) saying that the user X is now at the station N to begin their journey to the destination D. This step is called the check-in for the journey. As an alternative to steps 3-5 of this stage II, if the user X has a smartphone or computer with a geolocation function and Internet access, as the user X approaches the station, his/her telephone or computer can send the notification to the computer system (3) that the user X is now at the station N to begin their journey to the destination D.

III) Grouping

1. Every period of time T (for example, 1 or 2 minutes), the computer system (3) calculates the total number of seats that are required during the next period T to meet the demand at the station N. As needed—based on the number of vehicles that are going to come through the station N over the course of the next period T, the destinations of those vehicles, and the number of seats available in each of them—the computer system (3) dispatches additional empty vehicles to the station N to meet the demand at that station.

2. As the users check in at the station N, the computer system (3) performs the following steps:

a. It assigns a boarding group G to each user, according to their destination and their profile, considering the profiles of the other users that have checked in or are checking in, the order in which the vehicles will come through the station N in the next period T (or any of the subsequent periods), as well as the availability of seats and the profiles of the other passengers on those vehicles. The boarding group is a consecutive number (turn number), which the computer system (3) assigns to a group of users who will be able to pass to the boarding platform within a limited period of time. The size of the boarding group may vary depending on the circumstances (for example, peak hour or off-peak hour), from a single passenger for one vehicle up to several dozen passengers for several vehicles. Although the boarding group identifiers are consecutive, the computer system (3) does not need to assign them consecutively.

In the case of the user X, the computer system (3) assigns him/her a boarding group so as to provide the transportation service without exceeding a maximum waiting time. The predefined maximum waiting time does not need to be the same for all users: the computer system can give priority to those users who made a reservation for a certain time and who actually checked in at the time stated in their reservation, giving these persons a shorter maximum waiting time. As the interval between the check-in time and the reservation time gets greater, the computer system (3) can extend the maximum waiting time for that user.

b. It assigns a destination to those vehicles that do not yet have a scheduled destination, either because they are arriving empty at the station N or because they are leaving all of their passengers at the station N. As needed, the computer system (3) can also assign additional destinations to those vehicles that already have a destination.

c. It assigns each boarding group a specific vehicle or a group of consecutive vehicles that will be coming through the station N.

3. The computer system (3) sends to the kiosk with the printer (5) the number of the boarding group G that was assigned to the user X.

4. The printer (5) prints the number G on the turn slip for the user X. As an alternative to steps 3 and 4 of this stage III, if the user X has a mobile telephone or mobile computer device with Internet access, the computer system (3) sends the user X a message (SMS, electronic mail or other kind) with their boarding group identifier G and the telephone or computer device displays this identifier G on its screen. This boarding group identifier can be a number, a text, an image, a combination of these, etc.

IV) Call

5. Shortly before the vehicle or vehicles corresponding to the boarding group G come through the station N, the screen (6) at the station displays the identifier G. Thus, the user X (together with the rest of the users in the same boarding group) can approach the access control mechanisms of the boarding platform (7) as their turn to board draws nearer.

6. When the screen (6) displays the group identifier G, the access control mechanisms (7) with readers (2) allow those users carrying the means or devices of identification (1) which the computer system (3) has linked to the group identifier G, to pass.

7. Each vehicle coming through the station N has displayed on its screen (8) the number G that was assigned to it for that station and the destination(s) where that vehicle is headed. Optionally, they can display the usernames of the users who are to board that vehicle.

8. The user X arrives at the boarding platform and briefly waits there for the vehicle to come through with the group identifier G matching the number he/she was assigned and with the destination he/she chose. When that vehicle arrives, the user boards it.

9. Optionally, the reader device (2) in the vehicle reads the identification card of the user X and sends the computer system (3) a notification that the user X is now in the vehicle.

V) Journey

10. The computer system (3) confirms that the user X has boarded the correct vehicle, and the vehicle continues its journey towards the destination D (and other destinations programmed by the computer system).

11. The vehicle stops only at the destination stations of the users who are now aboard the vehicle. If any there are still seats available, the vehicle can also stop at one of the remaining stations along the way to pick up another user who has a profile compatible with that of the users in the vehicle and who is headed to the station D or nearby.

12. Upon arriving at the station D, the user X gets off the vehicle and the computer system (3) registers the fact that said seat is available once again. The purpose of the boarding group is to prevent users from entering the area of the boarding platform and jumping ahead of other users who are headed to the same destination and who arrived at the station before (and were assigned to a prior boarding group).

1-37. (canceled)

38. A system for grouping passengers in automated collective transportation, comprising:
a plurality of vehicles;
a plurality of stations where passengers can get on and off the vehicles, each station having a zone without controlled access and a zone with controlled access;
a computer system;
a plurality of identification devices that identify the passengers bearing each device or means of identification;
at least one recognition device fitted at each station, for reading or extracting relevant information contained in the identification device and sending this information to the computer system;
at least a first display device placed in the zone without controlled access of the stations, capable of displaying information generated by the computer system and indicating which passenger or group of passengers can pass to a boarding platform and at what time;
at least one access control mechanism fitted at each station, capable of allowing or denying the passengers to pass from the zone of the station without controlled access to the controlled access zone, wherein access is restricted to passengers who are authorized to board the vehicles on the boarding platform, according to instructions from the computer system;
at least a second display device placed in each vehicle capable of displaying information generated by the computer system and indicating the destination or destinations of that vehicle and/or the passenger or groups of passengers who are to board it; and
a means for transmitting information between the computer system and each of the recognition devices, the first display devices, the access control mechanisms and the second display devices, wherein:
a) grouping of passengers with destinations in common is performed on-the-fly as the passengers identify themselves with their identification device at the recognition device(s) and at that time indicate their destination to the computer system; and
b) said grouping is done virtually by the computer system before the passengers pass through the access control mechanism(s) that allow them to pass to the platform where the vehicles are boarded; and
c) assignment of the vehicle that will transport a group of passengers to their destination is done automatically by the computer system, before or after the virtual formation of the group of passengers; and
d) groups are formed physically just prior to boarding, when the computer system displays information on the first display device(s); and
e) an order in which the passenger groups go through the access control mechanism(s) and reach the platform matches an order in which the vehicles, each with their respective destination, pass in front of the platform.

39. The system for grouping passengers in automated collective transportation according to claim 38, wherein at least one of the passengers uses a card with a chip on which certain details of the passenger are programmed, a mobile telecommunication device, a mobile computer device, a card with a magnetic strip, an RFID-style card, or a biometric datum as the identification device.

40. The system for grouping passengers in automated collective transportation according to claim 38, further comprising at least one indicator device for receiving information generated by the computer system and transmitting this information to the passenger, said information containing a customized instruction that the passenger is to follow in order to board a vehicle that will take the passenger to his/her selected destination.

41. The system for grouping passengers in automated collective transportation according to claim 40, wherein at least one of the indicator devices comprises a device for printing the information sent by the computer system on a physical medium that is delivered to the passenger.

42. The system for grouping passengers in automated collective transportation according to claim 40, wherein the computer system sends an electronic message to the passenger through the indicator device.

43. The system for grouping passengers in automated collective transportation according to claim 38, wherein the first and second display devices comprise one or a combination of a visual medium, a sound medium and a touch medium.

44. The system for grouping passengers in automated collective transportation according to claim 38, wherein the computer system is in a single computer or in various computers connected on a network.

45. The system for grouping passengers in automated collective transportation according to claim 38, further comprising a database of passengers with information about certain attributes of each passenger and the preferences of each passenger regarding the attributes of other passengers, said preferences being considered by the computer system when forming groups of passengers who will travel together in the same vehicle.

46. The system for grouping passengers in automated collective transportation according to claim 45, wherein the attributes of a passenger in the database include a list of passenger groups of which this passenger is a member.

47. The system for grouping passengers in automated collective transportation according to claim 46, wherein the passenger groups are predefined by an administrator of the computer system or created by the passengers themselves.

48. The system for grouping passengers in automated collective transportation, according to claim 45, wherein the attributes of a passenger in the database include one or a combination of a list of those passenger groups with which the passenger is willing to share a vehicle (inclusion attributes), and a list of those passenger groups with which the passenger is not willing to share a vehicle (exclusion attributes).

49. The system for grouping passengers in automated collective transportation according to claim 45, wherein the preferences of a passenger in the database include one or more temporarily valid attributes, either for a certain number of journeys or for certain time schedules.

50. The system for grouping passengers in automated collective transportation according to claim 38, wherein a station may have more than one platform, in which case the system comprises recognition devices, first display devices and access control mechanisms for each platform.

51. A method for grouping passengers in automated collective transportation, comprising the following steps:
a. upon arriving at one of a plurality of stations, in a zone without controlled access, the passenger presents an identification device to a recognition device and chooses a destination station to which the passenger wants to travel;
b. the recognition device reads information that identifies the passenger bearing the identification device and sends it, together with the identification of the destination station, to a computer system;
c. the computer system, based on a profile of personal attributes and the passenger's preferences stored in a database, as well as the identification of destinations and preferences of other passengers at the same station and at other stations, forms passenger groups with common destinations and preferences and assigns a boarding group to the passenger, this group being periodically updated before the passengers pass through access control mechanisms to a platform;
d. the computer system sends a boarding group identifier assigned to the passenger to an indicator device;
e. the indicator device transmits to the passenger the boarding group identifier that was assigned to him/her;
f. the computer system, based on the vehicles that are arriving at the station and their respective destinations as well as seats available on each vehicle, displays on a first display device the identifiers of the boarding groups that can pass through to the platform to board a vehicle;
g. the computer system allows access through an access control mechanism only to those passengers who have been assigned to the boarding groups whose identifiers are being displayed on the display device, so that an order in which the passenger groups reach the platform matches an order in which the vehicles traveling to different destinations pass in front of the platform;
h. the passenger proceeds to the platform at the time indicated according to steps (f) and (g);
i. the computer system displays on a second display device in each vehicle the destination(s) to which that vehicle is heading and/or the identifiers of the boarding groups that are to board that vehicle, until the vehicle leaves the station;
j. the passenger boards the indicated vehicle that will take the passenger to his/her destination;
k. steps (a) through (e) are repeated for each passenger at each station, and steps (f) through (j) are repeated for each boarding group at each station.

52. The method for grouping passengers in automated collective transportation of claim 51, wherein the choice of the destination station in step (a) is optionally made by the passenger before arriving at the station by means of a travel reservation registered in the computer system.

53. The method for grouping passengers in automated collective transportation of claim 52, wherein the reservation is made by a computer application installed on a mobile computer or telecommunication device.

54. The method for grouping passengers in automated collective transportation of claim 51, wherein steps (a) and (b) are optionally performed automatically when the passenger approaches the station by a computer application installed on a mobile computer or telecommunication device carried by the passenger, which has a geolocation function.

55. The method for grouping passengers in automated collective transportation of claim 51, wherein the assignment of the boarding group identifier is the result of a function that maximizes the occupancy of each vehicle.

56. The method for grouping passengers in automated collective transportation of claim 55, wherein the assignment of the boarding group identifier is dependent on a predefined maximum waiting time of the passenger at the origin station.

57. The method for grouping passengers in automated collective transportation of claim 56, wherein the passenger's maximum waiting time at the origin station is different for different passengers and/or is a function that depends on the planned start time of the journey according to the reservation, the passenger's actual check-in time at the origin station, the difference between these two, or another combination of these and/or other variables handled by the computer system.

58. The method for grouping passengers in automated collective transportation of claim 55, wherein the assignment of the boarding group identifier is the result of a function that maximizes the number of passengers in a vehicle sharing at least one inclusion attribute in common according to the information stored in the database.

59. The method for grouping passengers in automated collective transportation of claim 55, wherein the assignment of the boarding group identifier is the result of a function that minimizes the number of passengers in a vehicle who do not share any inclusion attribute with the other passengers and/or that prevents another passenger from having attributes included in the exclusion attributes of another passenger according to the information stored in the database.

60. The method for grouping passengers in automated collective transportation of claim 51, wherein the length of time that a boarding group is displayed on the first display device is approximately equal to the length of time that the vehicle to be boarded by the passenger will remain at that station.

61. The method for grouping passengers in automated collective transportation of claim 51, wherein the size of the boarding group varies depending on the circumstances (for example, peak hour or off-peak hour), from a single passenger for one vehicle to several dozen passengers for several vehicles.

62. The method for grouping passengers in automated collective transportation of claim 51, wherein programming of at least one subsequent destination of any vehicle is changed if needed and without the passengers realizing it, just before the vehicles that will serve the demand come through the station to pick up the passengers.

63. The method for grouping passengers in automated collective transportation of claim 51, wherein a boarding group is only assigned to a passenger if the passenger has paid for the journey or has the right to make the journey.

64. The method for grouping passengers in automated collective transportation of claim 51, wherein the boarding group identifier that is displayed on the second display device when the vehicle is at a station can be different from the boarding group identifier displayed on the second display device of this vehicle when it is at the next station.

65. The method for grouping passengers in automated collective transportation of claim 51, wherein those passengers who prefer to travel anonymously are grouped with other passengers who are also travelling anonymously.

66. The method for grouping passengers in automated collective transportation of claim 51, wherein the boarding group identifier is one or a combination of numbers, texts and images.

67. The method for grouping passengers in automated collective transportation of claim 66, wherein the boarding group identifiers are consecutive numbers or consecutive letters, although the computer system does not necessarily assign them consecutively.

68. The method for grouping passengers in automated collective transportation of claim 66, wherein at step (f) a text or image being displayed that unmistakably identifies a certain group of passengers for whom it is obvious that the text or image refers to them, and for the other passengers who do not belong to that group, it is equally obvious that the text or image does not refer to them, and in that case step (e) of the method is eliminated.

69. The method for grouping passengers in automated collective transportation of claim 51, wherein the grouping of passengers is optionally done in more than one step at stations with more than one platform, first according to a first grouping criterion or set of criteria to distribute the passengers to the various platforms, and then by some other grouping criterion or set of criteria for each individual platform.
